(19) United States
(12) Patent Application Publication
(10) Pub. No.: US 2019/0062105 A1
(43) Pub. Date: Feb. 28, 2019

(54) SYSTEM AND METHOD FOR ENHANCING ELEVATOR POSITIONING

(71) Applicant: KONE Corporation, Helsinki (FI)

(72) Inventors: Sami SAARELA, Helsinki (FI); Aki HAIKONEN, Helsinki (FI); Klaus MÄKELÄ, Helsinki (FI); Sakke AHONIEMI, Helsinki (FI)

(73) Assignee: KONE Corporation, Helsinki (FI)

(21) Appl. No.: 16/172,202

(22) Filed: Oct. 26, 2018

Related U.S. Application Data
(63) Continuation of application No. PCT/EP2016/060011, filed on May 4, 2016.

(51) Int. Cl. B66B 1/34; B66B 5/00; B66B 3/00; B66B 1/28; G06T 7/50; G06T 7/00

(52) U.S. Cl. CPC B66B 1/3492; B66B 5/0012; B66B 3/002; B66B 5/0025; G06K 9/00624; G06T 7/50; G06T 7/0002; G06T 2207/10012; B66B 1/28

(57) ABSTRACT

A method and a system for enhancing elevator positioning includes a camera system designed to record pictures and a computer system designed to determine an absolute distance or a distance between two elements of the recorded pictures. The device is designed to determine the relative distance between the floor of an elevator car and the floor of a landing.

### FIELD OF THE INVENTION

The invention relates to a device and a method for enhancing elevator positioning, especially levelling of elevator cars at landings.

### BACKGROUND OF THE INVENTION

Every time an elevator stops and opens the doors, the floor of the elevator car should be levelled with the floor of the landing so that no step occurs. Such step may cause entering or leaving passengers to trip and may result in injuries of the passengers. In addition, persons having difficulties in walking or are dependent on walking frames or wheelchairs may be seriously affected by steps occurring while entering an elevator car.

There are known systems used for elevator positioning against landings, since every elevator requires some kind of a positioning system to be able to operate.

These systems provide the disadvantage that they use mechanical sensors or light barriers that regulate levelling of the elevator cars, however, if one of these sensors is not positioned correctly, de-positioned or broken, poor levelling may occur resulting in steps to or from the elevator floor to the landing floor.

### AIM OF THE INVENTION

The aim of the present invention is to disclose a solution, which eliminates or at least alleviates the one or more of the drawbacks occurring in prior-art solutions presented above, and to disclose an elevator system which is optimized in regard to the prior art, especially in regard to enable an enhanced levelling accuracy and removing risks caused by poor levelling.

The invention especially also enables to keep an elevator system operational even in the case of broken or de-positioned components used for levelling elevator cars. In addition, the present invention may be used to detect and count passengers using an elevator.

### SUMMARY OF THE INVENTION

The device and the method according to the invention and preferred embodiments are characterized by the claims. Some further inventive embodiments are also presented in the descriptive section and in the drawings of the present application. The inventive content of the application can also be defined differently than in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. The features of the various embodiments of the invention can be applied within the scope of the basic inventive concept in conjunction with other embodiments.

The system for enhancing elevator positioning according to the invention comprises a camera system designed to record pictures and a computer system designed to determine an absolute distance of at least one element of the recorded pictures or a relative distance between two elements of the recorded pictures, wherein the device is designed to determine the relative distance between the floor of an elevator car and the floor of a landing.

The method for enhancing elevator positioning according to the invention comprises the steps:
recording pictures of the floor of an elevator car and the floor of a landing with the camera system,
determining with the computer system an absolute distance of the floor of an elevator car and/or the floor of a landing or a relative distance between the floor of an elevator car and the floor of a landing.

Camera systems are well known. In the simplest embodiment, a single camera is used. Preferred are camera systems that provide two stereoscopic pictures or distance informations (plenoptic (light-field) camera or 3D-camera).

The cameras must be arranged such that they at least record pictures of the floor that is moving relative to the camera (cameras arranged at the landing floor record at least the floor of an elevator car, cameras in an elevator car record at least the floor of the landings), and/or at least such that they record marks that unambiguously indicate the location of said floor. The combination of recording at least one mark (e.g. at the walls) and at least one floor, wherein the mark indicates the position of the respective floor offers the advantage that if the mark is eventually hidden or the floor cannot be seen due to an obstacle standing there, the system can still measure the levelling condition due to the redundant measurements.

At least one camera is especially positioned at floor level of one floor (car-floor or landing-floor) and recording the opposite floor (landing-floor or car-floor). Preferred is an embodiment, where at least one camera of the camera system is positioned above the doors of a landing floor or an elevator car and is aimed down towards the floor, especially straight down or at least under an angle of less than 30° (or less than 10°) to the vertical direction.

In a preferred embodiment the camera begins recording images, and/or the system begins image analyzing, as soon as the doors start to open.

Computer systems are well known. They comprise processors or controllers together with a RAM and especially a non-volatile memory. Also the method of object recognition in pictures is known. The computer system is designed to recognize the floor of an elevator car and/or the floor of a landing, the edge between these floors, or at least above mentioned marks indicating the position of said floors.

Although it is possible to record only one floor (car-floor or landing-floor), at least as long as the distance of the other floor to the camera is known, it is preferred that the camera system is able to record both floors to reduce errors. In a simple embodiment, one camera records both floors after the opening of the doors, wherein the position of the camera is inside the car or outside the levelling door and the computer system measures the dimensions of the edge between the two floors. If the breadth of the edge in a 2D-picture is smallest (or below a predefined value), both floors are exactly levelled, if the edge is not smallest (or above said predefined value) one floor is higher than the other floor.

By using a higher evolved camera (e.g. pleoptic camera or 3D-camera) the relative or absolute distance(s) of the floors can be measured and the levelling of the floors can be calculated by using the measured distance(s).

In a preferred embodiment, the computer system is designed to store reference images of each landing to compare current images against the reference images. When the system then detects a deviation either between car floor and landing floor or current image against reference image at that specific landing, the computer system concludes that the elevator is poorly levelled.

In a preferred embodiment the system for enhancing elevator positioning comprises the elevator system or is at least designed to be included in an elevator system, wherein the camera system is designed to be positioned at the doors of the elevator system. The camera system is preferably located at at least one door area of an elevator system either on the car side or landing side. Preferably, the camera system is positioned inside the car, providing the advantage that only one camera system has to be used to control many different floors.

As preferred alternative, the camera system is positioned at the door of a landing, providing the advantage that only one camera system has to be used to control many different cars of a multi-car-elevator.

In a preferred embodiment, the system is designed to detect and/or count passengers entering or leaving an elevator car.

In a preferred embodiment, the system comprises a known, camera-based passenger detector system with its passenger detecting shape recognition software. To achieve the aim of the present invention, that system has to be modified in that it recognizes the car floor and/or the landing floors (either absolute distance or relative distance between these two floors).

It is preferred that the analysis of the correctness of the levelling will happen in the first moments of the door opening to prevent persons entering or leaving a poorly levelled elevator car. The time between the beginning of door opening and analysing the levelling condition by the system is especially shorter than 10 seconds, preferably shorter than 5 seconds. It is preferred that at the end of the analysis of the levelling by the system the elevator doors are not completely open but have especially opened less than 50 cm or even less than 10 cm. In the case of poor levelling it is preferred that the elevator is controlled not to open the doors further, but to close the doors and preferably to move to an adjacent floor, or to move slowly to a position where a correct levelling is assumed. By measuring the distances of the floors the computer system is also able to provide the correct levelling position of the elevator and may send the correct moving distance to the elevator system. This will prevent boarding or leaving of passengers in poor levelling situations.

In a preferred embodiment, the system also comprises acoustic or optic warning means (e.g. selected from the group sirens, beepers, loudspeakers, displays and lights), where especially the respective means of the elevator system are used. When poor levelling is detected, this embodiment will warn passengers immediately e.g. by a repeating warning beep and also possibly by texts in COP or others displays in car.

In a preferred embodiment, information of being poorly levelled, is transmitted to the elevator control system together with the landing number and/or car number where poor levelling occurred. If the elevator control system is unable to determine the exact elevator position, (elevator car too low or too high), The system of the invention may assist, as said above with the calculated moving distance of the car or the elevator system may do re-levelling by trial and error, i.e. the elevator control system will move the elevator car very slowly in one direction and see if the levelling information through the system of the invention is improved or worsened. After re-levelling, the doors can be opened again and measuring is accomplished while the doors are still opening, if the elevator car is still badly levelled, the system can compare this measurement with the last measurement to detect if the levelling has been improved or worsened and can recursively (with maybe more measuring steps) calibrate the elevator car at a good levelling position.

In a preferred embodiment, the system will generate a service need message to the elevator control system (e.g. via Kone Remote Monitoring System) to get the next planned maintenance visit closer.

In a preferred embodiment, a detection of a first poor levelling will trigger a “limp mode” which allows an elevator to move between all other landings except the one, where poor levelling was detected. In this embodiment, the system of the invention would detect abnormal levelling behaviour in a landing and will interpret this in that some component at that landing is causing levelling problems. The elevator would preferably not operate at that landing until a maintenance would have taken place. This is especially applicable for older elevator systems where a re-levelling is not possible.

In a further preferred embodiment that is especially advantageous in the case where one or more floors have been detected to have poor levelling or if an elevator car has been detected to be the reason for poor levelling, the elevator car is parked to await maintenance, preferably at a predefined parking position. Thus, the system is designed to comprise a predefined parking position and to comprise a moving routine to move the elevator car to this predefined parking position.

### LIST OF FIGURES

In the following, the invention will be described in detail by the aid of examples of its embodiments, wherein:

FIG. 1 outlines a preferred system.

FIG. 2 outlines the method of the invention.

### DETAILED DESCRIPTION OF THE INVENTION

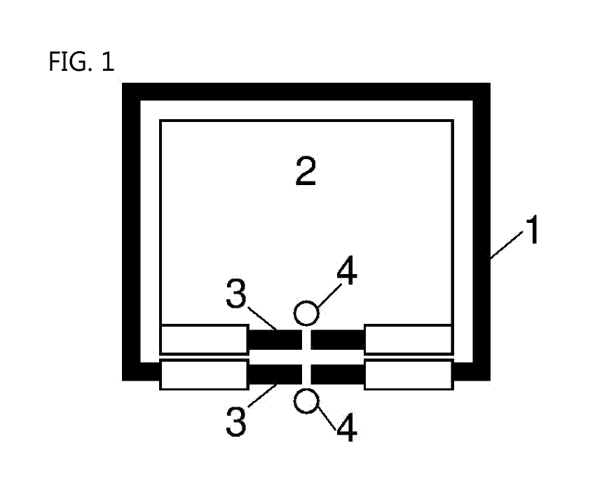

FIG. 1 shows an elevator car 2 in an elevator shaft 1, where the doors 3 of the elevator car are opposite the doors 3 of a landing, which is a situation where the elevator car 2 stops at the landing or reaches the landing. The circles 4 mark possible positions of a camera of the system. A camera could be installed in the position of the circle 4 in the elevator car 2 or outside the elevator car 2 at the landing. In general, all positions, where the floors can be recorded when opening the doors 3 are possible positions for cameras.

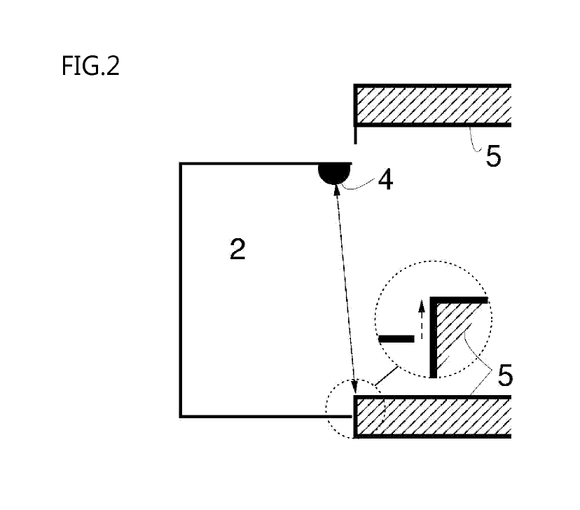

FIG. 2 outlines the method of the invention. Here a camera is arranged at the position of the semi circle 4 at the ceiling of the elevator car, that possibly may be centred regarding the doors (not shown here) as shown in FIG. 1 (inner circle 4 of FIG. 1). The arrow directing to and from the semi-circle 4 should refer to the line of sight of the camera. Surely, the downward arrow points just at the centre of the recorded image that shows the floor of the elevator car and the floor of the landing 5. When opening the doors, the camera starts to record images of said floors, especially together with distance informations. As shown in FIG. 2 (enlarged picture of the edge), the elevator is poorly levelled, since there is a step between the floor of the elevator car and the floor of the landing. If using only one camera, this step could be seen as an edge between the two floors that is broader than the edge would be in a perfect levelled situation. If using a stereoscopic camera, the step would appear in the stereoscopic images, if using a 3D-camera, the different distances of the car-floor and the landing-floor at their facing edges would be measured.

By moving the elevator car slowly in the direction of the broken arrow (in the broken circle of the enlargement) the car can be levelled again.

This figure makes it also clear why it is possible to measure only the distance of the floor that is moving relative to the camera (here landing-floor), since the distance of the floor not moving relative to the camera (here car-floor) is constant and may, therefore, be present as a predefined value in the computer system.

1. A system for enhancing elevator positioning, comprising:
a camera system designed to record pictures; and
a computer system designed to determine an absolute distance of at least one element of the recorded pictures or a relative distance between two elements of the recorded pictures,
wherein the device is designed to determine the relative distance between the floor of an elevator car and the floor of a landing.

2. The system as claimed in claim 1, wherein the camera system comprises a single camera or is a camera system that provides two stereoscopic pictures and/or distance information.

3. The system as claimed in claim 1, wherein at least one camera of the camera system is positioned above the doors of a landing floor or an elevator car and is aimed down towards the floor.

4. The system as claimed in claim 1, wherein the computer system is designed to store reference images of each landing to compare current images against the reference images, and wherein the computer system is designed to conclude a poor levelling when the system detects a deviation either between car floor and landing floor or current image against reference image at that specific landing.

5. The system as claimed in claim 1, wherein the system comprises a camera-based passenger detector system with passenger detecting shape recognition software, and wherein the system is modified to recognize the car floor and/or the landing floors.

6. The system as claimed in claim 1, further comprising acoustic or optic warning means.

7. A method for enhancing elevator positioning with the system according to claim 1, comprising the steps of:
recording pictures of the floor of an elevator car and the floor of a landing with the camera system; and
determining with the computer system an absolute distance of the floor of an elevator car and/or the floor of a landing or a relative distance between the floor of an elevator car and the floor of a landing.

8. The method as claimed in claim 7, wherein the camera begins recording images, or the system begins image analyzing, as soon as the doors start to open, and wherein the time between the beginning of door opening and analysing the levelling condition by the system is especially shorter than 10 seconds, and/or wherein the doors have especially opened less than 50 cm.

9. The method as claimed in claim 8, wherein information of being poorly levelled is transmitted to an elevator control system together with the landing number and/or car number where poor levelling occurred and/or the elevator is controlled not to open the doors further, but to close the doors and to move to an adjacent floor, or to move slowly to a position where a correct levelling is assumed, and wherein in the case where one or more floors have been detected to have poor levelling or if an elevator car has been detected to be the reason for poor levelling, the elevator car is parked to await maintenance.

10. An elevator system, comprising the system as claimed in claim 1.

11. The system as claimed in claim 1, wherein the camera system comprises a single camera or is a camera system that provides two stereoscopic pictures and/or distance information, and comprises a plenoptic camera or a 3D-camera.

12. The system as claimed in claim 1, wherein at least one camera of the camera system is positioned above the doors of a landing floor or an elevator car and is aimed down towards the floor, straight down or at least under an angle of less than 30° to the vertical direction.

13. The system as claimed in claim 1, further comprising acoustic or optic warning means selected from the group sirens, beepers, loudspeakers, displays and lights, where the respective means of the elevator system are used.

14. The system as claimed in claim 2, wherein at least one camera of the camera system is positioned above the doors of a landing floor or an elevator car and is aimed down towards the floor.

15. The system as claimed in claim 2, wherein the computer system is designed to store reference images of each landing to compare current images against the reference images, and wherein the computer system is designed to conclude a poor levelling when the system detects a deviation either between car floor and landing floor or current image against reference image at that specific landing.

16. The system as claimed in claim 3, wherein the computer system is designed to store reference images of each landing to compare current images against the reference images, and wherein the computer system is designed to conclude a poor levelling when the system detects a deviation either between car floor and landing floor or current image against reference image at that specific landing.

17. The system as claimed in claim 2, wherein the system comprises a camera-based passenger detector system with its passenger detecting shape recognition software, wherein the system is modified to recognize the car floor and/or the landing floors.

18. The system as claimed in claim 3, wherein the system comprises a camera-based passenger detector system with its passenger detecting shape recognition software, wherein the system is modified to recognize the car floor and/or the landing floors.

19. The system as claimed in claim 4, wherein the system comprises a camera-based passenger detector system with its passenger detecting shape recognition software, wherein the system is modified to recognize the car floor and/or the landing floors.

20. The system as claimed in claim 2, further comprising acoustic or optic warning means selected from the group sirens, beepers, loudspeakers, displays and lights, where the respective means of the elevator system are used.
